(19) United States
(12) Patent Application Publication
(10) Pub. No.: US 2006/0203158 A1
(43) Pub. Date: Sep. 14, 2006

(54) Compensated lcd of the ips mode

(76) Inventors: Owain Llyrr Parri, Ringwood (GB); Karl Skjonnemand, Southampton (GB); Mark Verrall, Shilin (TW)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/551,951

(22) PCT Filed: Mar. 19, 2004
(86) PCT No.: PCT/EP04/02918

§ 371 Date: Oct. 6, 2005

(30) Foreign Application Priority Data
Apr. 8, 2003 (EP) 03007919.8

(51) Int. Cl. G02F 1/1335

(52) U.S. Cl. 349/117

(57) ABSTRACT

The invention relates to a compensated liquid crystal display (LCD) of the In Plane Switching (IPS) mode and to a compensator for use in an IPS-LCD.

### FIELD OF THE INVENTION

The invention relates to a compensated liquid crystal display (LCD) of the In Plane Switching (IPS) mode and to a compensator for use in an IPS-LCD.

### BACKGROUND AND PRIOR ART

Liquid Crystal Displays (LCDs) are widely used to display information. LCDs are used for direct view displays, as well as for projection type displays. Electro-optical modes employed are e.g. the twisted nematic (TN)-, the super twisted nematic (STN)-, the optically compensated bend (OCB)- and the electrically controlled birefringence (ECB)-mode with their various modifications, as well as others. All these modes use an electrical field, which is substantially perpendicular to the substrates, respectively to the liquid crystal layer. Besides these modes there are also electro-optical modes employing an electrical field substantially parallel to the substrates, respectively the liquid crystal layer, like e.g. the In-Plane Switching mode as disclosed e.g. in DE 40 00 451 and EP 0 588 568. Especially this electrooptical mode is used for LCDs for modern desktop monitors and is envisaged to be applied for displays for multi media applications.

The viewing angle of IPS mode LCD is usually good, however at certain oblique viewing angles, the image quality can deteriorate. This is largely influenced by the fundamental limitations of the polariser sheets (see e.g. J E Anderson and P J Bos; J. of Japn. App. Phys., Vol 39, (2000), 6388 or Yukito Saitoh et al, Jpn. J. of Appl. Phys. 37 (1998), 4822-4828). Methods of compensating this mode have also been disclosed in prior art. For example, U.S. Pat. No. 6,115,095 describes an IPS display that comprises a first optically uniaxial positive compensation layer with an optical axis perpendicular to the plane of the layer (+C plate) and optionally a second optically uniaxial positive compensation layer with an optical axis parallel to the plane of the layer (+A plate). U.S. Pat. No. 6,184,957 describes an IPS display comprising an optically uniaxial negative compensation layer with an optical axis parallel to the plane of the layer (−A plate), which is formed by a discotic LC film.

However, the compensation sheets described in prior art to compensate IPS mode displays are either difficult to manufacture on a large scale, like e.g. the homeotropically aligned discotic film as described in U.S. Pat. No. 6,184,957, or tend to suffer from some durability problems described and are particularly difficult to manufacture for large area displays, like e.g. the stretched polymeric films which are usually employed as +A and +C plates. In addition the manufacturing costs of an IPS compensator are often relatively expensive because the A-plate should preferably be located such its slow axis is perpendicular to the stretch direction of the polariser.

Also, in particular when compensating a Normally Black-(NB)-IPS mode LCD, which is not transmissive when the electric field is not applied, an important factor that should be considered is the birefringent film substrate that is attached to the polarisers. Usually this is a plastic film of a slightly birefringent material like for example triacetylcellulose (TAC). In the case of NB-IPS displays these films often deteriorate the viewing angle of the display and are, in effect additional features which must be compensated. (J E Anderson and P J Bos; J. of Japanese App. Phys., Vol 39, (2000), 6388).

One aim of the present invention is to provide a compensator for an LCD of the IPS mode that improves the optical performance of the LCD, in particular the contrast at wide viewing angles, is easy to manufacture, and allows economic fabrication even at large scales.

Another aim of this invention is to provide an advantageous use of the compensator according to this invention.

A further aim of this invention relates to an IPS-LCD comprising an inventive compensator which show advantageous properties such as good contrast, reduced colour shift and wide viewing angles.

Other aims of the present invention are immediately evident to the person skilled in the art from the following detailed description.

The above aims can be achieved by providing compensators and LCDs according to the present invention.

Definition of Terms

In connection with polarisation, compensation and retardation layers, films or plates as described in the present application, the following definitions of terms as used throughout this application are given.

The term ‘film’ as used in this application includes self-supporting, i.e. free-standing, films that show more or less pronounced mechanical stability and flexibility, as well as coatings or layers on a supporting substrate or between two substrates.

The term ‘liquid crystal or mesogenic material’ or ‘liquid crystal or mesogenic compound’ should denote materials or compounds comprising one or more rod-shaped, board-shaped or disk-shaped mesogenic groups, i.e. groups with the ability to induce liquid crystal phase behaviour. Liquid crystal (LC) compounds with rod-shaped or board-shaped groups are also known in the art as ‘calamitic’ liquid crystals. Liquid crystal compounds with a disk-shaped group are also known in the art as ‘discotic’ liquid crystals. The compounds or materials comprising mesogenic groups do not necessarily have to exhibit a liquid crystal phase themselves. It is also possible that they show liquid crystal phase behaviour only in mixtures with other compounds, or when the mesogenic compounds or materials, or the mixtures thereof, are polymerised.

For the sake of simplicity, the term ‘liquid crystal material’ is used hereinafter for both liquid crystal materials and mesogenic materials, and the term ‘mesogen’ is used for the mesogenic groups of the material.

The term ‘director’ is known in prior art and means the preferred orientation direction of the long molecular axes (in case of calamitic compounds) or short molecular axis (in case of discotic compounds) of the mesogens in a liquid crystal material.

The term ‘planar structure’ or ‘planar orientation’ refers to a film wherein the optical axis is substantially parallel to the film plane.

The term ‘homeotropic structure’ or ‘homeotropic orientation’ refers to a film wherein the optical axis is substantially perpendicular to the film plane, i.e. substantially parallel to the film normal.

In planar and homeotropic optical films comprising uniaxially positive birefringent liquid crystal material with uniform orientation, the optical axis of the film is given by the director of the liquid crystal material.

The term ‘A plate’ refers to an optical retarder utilizing a layer of uniaxially birefringent material with its extraordinary axis oriented parallel to the plane of the layer.

The term ‘C plate’ refers to an optical retarder utilizing a layer of uniaxially birefringent material with its extraordinary axis perpendicular to the plane of the layer.

In A- and C-plates comprising optically uniaxial birefringent liquid crystal material with uniform orientation, the optical axis of the film is given by the direction of the extraordinary axis.

An A plate or C plate comprising optically uniaxial birefringent material with positive birefringence is also referred to as ‘+A/C plate’ or ‘positive A/C plate’. An A plate or C plate comprising a film of optically uniaxial birefringent material with negative birefringence is also referred to as ‘−A/C plate’ or ‘negative A/C plate’.

A retardation film with positive or negative birefringence is also shortly referred to as ‘positive’ or ‘negative’ retardation film, respectively.

A transmissive or transflective LCD according to the present invention preferably contains a polariser and an analyser, which are arranged on opposite sides of the arrangement of LC layer and birefringent layer.

Polariser and Analyser are jointly referred to as “polarisers” in this application.

### SUMMARY OF THE INVENTION

The invention relates to a liquid crystal display (LCD) of the In Plane Switching (IPS) mode comprising
at least one first retardation film comprising optically uniaxial positive calamitic LC material and having an optical axis substantially parallel to the film plane (+A plate),
at least one first retardation film comprising optically uniaxial positive calamitic LC material and having an optical axis substantially perpendicular to the film plane (+C plate).

The invention further relates to a liquid crystal display (LCD) of the In Plane Switching (IPS) mode comprising a switchable LC cell sandwiched between two polarisers, said LC cell comprising a layer of an LC medium between two plane parallel substrates at least one of which is transparent to incident light, wherein the LC molecules are reoriented by application of an electric field that has a major component substantially parallel to the substrates, characterized in that the LCD comprises
at least one first retardation film comprising optically uniaxial positive calamitic LC material and having an optical axis substantially parallel to the film plane (+A plate),
at least one first retardation film comprising optically uniaxial positive calamitic LC material and having an optical axis substantially perpendicular to the film plane (+C plate).

The invention further relates to compensator, especially for use in an LCD of the IPS mode, comprising at least one +A plate and at least one +C plate as described above and below, and optionally comprising a linear polariser.

### BRIEF DESCRIPTION OF THE DRAWINGS

FIG. 1 exemplarily and schematically depicts a compensated IPS display according to a preferred embodiment of the present invention.

FIG. 2 shows the simulated isocontrast plot of an uncompensated IPS display of prior art.

FIGS. 3, 4 and 5 show the simulated isocontrast plot of a compensated IPS display according to example 1, 2 and 3, respectively, of the present invention.

FIG. 6 shows the simulated isocontrast plot of an uncompensated IPS display of prior art.

FIGS. 7, 8, 9, 10, 11 and 12 show the simulated isocontrast plot of a compensated IPS display according to example 4, 5, 6, 7, 8 and 9, respectively, of the present invention.

### DETAILED DESCRIPTION OF THE INVENTION

The compensator according to this invention comprises specific combinations of individual compensation films, preferably made from positive uniaxial calamitic reactive mesogens (RM), that provide good viewing angle performance with improved chromaticity. The individual films are formed by in-situ photopolymerisation of the RMs. Two types of films can be used in various combination: planar or homeotropic films. These have the additional attractive property of being thin and have high durability.

In addition, when using standard type absorption polarisers comprising e.g. stretched iodine/polyvinylalcohol (PVA) and protective triacetyl cellulose (TAC) layers, the inventors of the present invention have found that it is possible to provide a new polariser structure which places the compensating retardation film formed from reactive LCs between the stretched iodine/PVA layer and the protective TAC layer. This particular arrangement is especially advantageous for NB-IPS compensators.

The compensator according to the present invention can consist of individual +A plate and +C plate films or layers that are situated on the same or different sides of the switchable LC cell in a display.

In a preferred embodiment, the compensator is a multilayer comprising at least one, preferably one +A plate, and at least one, preferably one, +C plate, and optionally comprising one or more linear polarisers. The individual +A plate, +C plate and optionally the linear polarisers can form a multilayer, wherein they can be laminated directly onto each other or be connected via transparent intermediate films, like for example TAC, DAC or PVA films or by adhesive layers like for example pressure sensitive adhesives (PSA), and are optionally covered by one or more hardcoat or protective layers.

It is also possible that the individual +A plate, +C plate and optionally the linear polarisers form a monolithic film.

A preferred embodiment of the present invention relates to a particular compensator structure in which the slow axis of the +A plate is parallel to the stretch direction of the adjacent polariser. This embodiment achieves excellent compensation especially for NB-IPS, and is particularly attractive as it makes production easier and allows to reduce manufacturing costs. In contrast, the majority of suitable film compensators suggested in prior art for IPS mode have the slow axis of the +A plate perpendicular to the stretch direction of the adjacent polariser.

In a preferred embodiment of the present invention the RM films are manufactured by using a roll-to-roll coating method to align the +A plate optic axis with that of the adjacent polariser. This allows direct lamination of the +A plate roll to that of the polariser, and also gives the most improved optical performance.

In another preferred embodiment of the present invention, the +A plate and/or the +C plate are situated, between the substrates of the switchable LC cell of the display (“inside the LC cell”, “incell application”).

For some applications it is desirable to place the optical compensator film not outside the switchable LC cell of a display, but between the substrates, usually glass substrates, forming the switchable LC cell and containing the switchable LC medium (“incell application”). Compared to conventional displays where optical retarders are usually placed between the LC cell and the polarisers, incell application of an optical retardation or compensation film has several advantages. For example, a display where the optical film is attached outside of the glass substrates forming the LC cell usually suffers from parallax problems, which can severely impair viewing angle properties. If the optical film is prepared inside the LC display cell, these parallax problems can be reduced or even avoided.

Furthermore, incell application of the optical retardation or compensation film allows to reduce the total thickness of the LCD device, which is an important advantage for flat panel displays. Also, the displays become more robust. Especially advantageous for incell application is a film comprising polymerised LC material according to the present invention, as it can be made thinner due to the higher birefringence of the LC material compared e.g. to stretched plastic films. Thus, a film with a thickness of 2 microns or less can be used, which is especially suitable for incell applications.

It is also possible that one of the +A and +C plates is provided inside the LC cell and the other is outside the cell and for example provided or laminated onto the polariser. In a preferred embodiment all +A and +C plates are provided inside the LC cell. In another preferred embodiment the +A plate is inside the LC cell and the +C plate is outside the LC cell. In another preferred embodiment the +C plate is inside the LC cell and the +A plate is outside the LC cell.

In another preferred embodiment of the present invention, the +A plate and/or the +C plate are provided directly on one or both of the substrates of the switchable LC cell of the display (“on the LC cell”, “oncell application”).

It is also possible that one of the +A and +C plates is provided on the LC cell and the other is not provided directly on the cell substrate, but for example provided or laminated onto the polariser. In a preferred embodiment all +A and +C plates are provided on the LC cell. In another preferred embodiment the +A plate is on the LC cell and the +C plate is not on the LC cell. In another preferred embodiment the +C plate is on the LC cell and the +A plate is not on the LC cell.

For incell and oncell aplications, the +A plate and/or +C plate are preferably prepared on (either the innner or the outer side of) the substrate of the LC cell by spin-coating a polymerisable LC material, aligning it and fixing the aligned material by in situ polymerisation. Often the spin-coating itself provides sufficient alignment of the polymerisable LC material.

Another advantage of the compensator of the present invention is that, by using a combination of homeotropic and planar films of calamitic RMs, which have similar dispersion to the calamitic LC mixture as used in typical IPS display cells, undesired colouration is reduced. In contrast, for example a compensator as described in U.S. Pat. No. 6,184,957 uses compensation films made from discotic LC materials, which show a dispersion mismatch with the calamitic LCs in the display cell, and thus produce undesired colouration.

In a preferred embodiment of the present invention the individual +A and +C plates of the compensator comprise a polymerised LC material, the optical dispersion (the wavelength dependence of the birefringence) of which is matched to that of the LC material in the switchable display cell.

The film combinations according to the present invention compensate for both the polariser light leakage and the retardation of the LC in the IPS LCD in the dark state.

The +A plate retarder preferably comprises a polymerised LC material with planar structure as described for example in WO 98/04651, the entire disclosure of which is incorporated by reference.

The +C plate retarder preferably comprises a polymerised LC material with homeotropic structure as described for example in WO 98/00475, the entire disclosure of which is incorporated by reference.

The linear polarisers can be standard type absorption polarisers, for example comprising stretched iodine/polyvinylalcohol (PVA) and optionally protective triacetyl cellulose (TAC) layers. In another preferred embodiment of the present invention the linear polarisers comprise a polymerised or crosslinked LC material, preferably a calamitic LC material, and optionally one or more absorbing dyes, as described for example in EP 0 397 263. Commercially available polarisers are usually provided on a transparent birefringent substrate like e.g. a TAC film.

Especially preferred are the following embodiments
the compensator comprises one positive A plate (+A plate),
the compensator comprises one positive C plate (+C plate),
the +A plate and +C plate are situated on the same side of the switchable LC cell,
the +A plate and +C plate are situated between the LC cell and the polariser,
the +A plate and/or the +C plate are situated between the substrates of the LC cell,
the polarisation direction of the linear polarisers are crossed at right angles,
the optical axis of the +A plate is parallel to the stretch axis of the polariser that is situated on the same side of the LC cell as the +A plate,
the +A plate and/or +C plate comprise a polymerised or crosslinked LC material, preferably a calamitic LC material,
the +A plate comprises a polymerised or crosslinked achiral calamitic LC material with planar orientation,
the +C plate comprises a polymerised or crosslinked achiral calamitic LC material with homeotropic orientation,
the thickness of the +A plate is from 0.6 to 1.6 μm, preferably 0.9 to 1.3 μm
the thickness of the +C plate is from 0.4 to 1.0 μm, preferably from 0.6 to 0.8 μm

The optical retardation d_{A}·Δn_{A} of the +A plate is preferably from 50 to 200 nm, very preferably from 69 to 184 nm, most preferably from 104 to 150 nm.

The optical retardation d·Δn of the +C plate is preferably from 30 to 150 nm, very preferably from 46 to 115 nm, most preferably from 69 to 92 nm.

Especially preferred configurations of the individual optical films and other components in a display or compensator according to the present invention are shown in table 1. Therein, LC denotes the liquid crystal cell, P denotes a linear polariser, A denotes a +A plate, and C denotes a +C plate. The numbers in brackets denote the orientation angle (in degrees) of the optical axis of the +A and +C plate, the polarising direction of the polarisers P. or the preferred orientation direction of the LC molecules in the LC cell, respectively, in the direction parallel to the plane of the individual films or parallel to the substrates of the LC cell.

TABLE 1
Preferred compensator stacks

| | | | | | |
|---|---|---|---|---|---|
| 1) | P(90) | C | A(90) | LC(0) | P(0) |
| 2) | P(90) | A(0) | C | LC(0) | P(0) |
| 3) | P(90) | LC(0) | A(90) | C | P(0) |
| 4) | P(90) | LC(0) | A(0) | C | P(0) |
| 5) | P(90) | A(0) | LC(0) | C | P(0) |
| 6) | P(90) | A(90) | LC(0) | C | P(0) |
| 7) | P(90) | A(90) | C | LC(90) | P(0) |
| 8) | P(90) | C | LC(0) | A(90) | P(0) |
| 9) | P(90) | LC(0) | C | A(90) | P(0) |
| 10) | P(90) | C | A(0) | LC(90) | P(0) |
| 11) | P(90) | C | LC(0) | A(0) | P(0) |
| 12) | P(90) | LC(0) | C | A(0) | P(0) |
| 13) | P(90) | LC(90) | C | A(90) | P(0) |
| 14) | P(90) | C | A(0) | LC(90) | P(0) |
| 15) | P(90) | LC(90) | A(0) | C | P(0) |
| 16) | P(90) | C | A(90) | LC(90) | P(0) |
| 17) | P(90) | C | LC(90) | A(90) | P(0) |
| 18) | P(90) | A(0) | C | LC(90) | P(0) |
| 19) | P(90) | LC(90) | A(90) | C | P(0) |
| 20) | P(90) | A(0) | LC(90) | C | P(0) |
| 21) | P(90) | A(90) | LC(90) | C | P(0) |
| 22) | P(90) | A(90) | C | LC(90) | P(0) |
| 23) | P(90) | C | LC(90) | A(0) | P(0) |
| 24) | P(90) | LC(90) | C | A(0) | P(0) |

Especially preferred are configurations 1, 2, 3, 4, 5, 13, 14, 15, 16 and 17, in particular 1, 4, 15 and 16, most preferred 1 and 15.

The single +A plate, +C plate and polariser in a compensator according to the present invention and also in the stacks shown in table 1 can be laminated directly onto each other or separated by one or more transparent intermediate films or substrates, like for example TAC films.

Especially preferred configurations of the individual films in a display or compensator according to the present invention, including transparent substrates, are shown in table 2. Therein, A, C, P, LC have the meanings given in table 1, and S denotes a transparent birefringent substrate.

S is preferably a birefringent substrate, like e.g. a stretched plastic film, prefereably a TAC, DAC or PVA film, very preferably a TAC film.

TABLE 2
Preferred compensator stacks including substrates

| | | | | | | | | | |
|---|---|---|---|---|---|---|---|---|---|
| 1) | S | P(90) | C | S | A(90) | LC(0) | S | P(0) | S |
| 2) | S | P(90) | S | C | A(90) | LC(0) | S | P(0) | S |
| 3) | S | P(90) | S | LC(0) | A(0) | C | S | P(0) | S |
| 4) | S | P(90) | S | LC(0) | A(0) | S | C | P(0) | S |
| 5) | S | P(90) | S | LC(90) | A(0) | C | S | P(0) | S |
| 6) | S | P(90) | S | LC(90) | A(0) | S | C | P(0) | S |
| 7) | S | P(90) | S | C | A(90) | LC(90) | S | P(0) | S |
| 8) | S | P(90) | C | S | A(90) | LC(90) | S | P(0) | S |

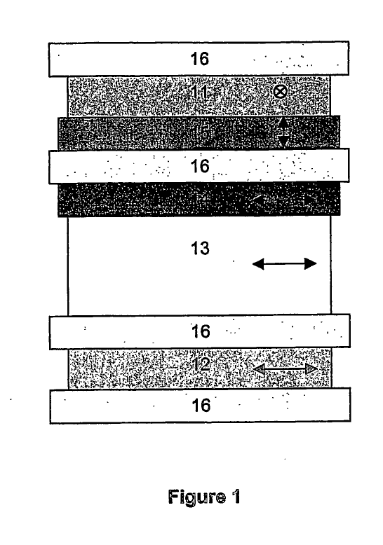

A display according to preferred stack No. 4 of table 2 is exemplarily shown in FIG. 1 in side view. Therein, 11 and 12 are linear polarisers, 13 is an LC cell of the IPS mode, 14 is a +A plate, 15 is a +C plate, and 16 is a TAC film. The orientation direction of the optical axis of the +A and +C plate, the polarising direction of the polarisers, and the preferred orientation direction of the LC molecules in the LC cell are shown by the arrows. The symbol “ [symbol] ” denotes the direction perpendicular to the drawing plane.

As previously mentioned, the birefringent substrates of the polarisers, like TAC, can reduce the viewing angle of film-compensated NB-IPS mode. The preferred configurations described in this invention exhibit this effect only for the TAC layer on the side of the LC cell opposite to that of the compensator. Provided that the +C plate is positioned adjacent to a TAC substrate, the stack shows just as good performance as when this layer of TAC is removed. The TAC on the opposite side of the LC cell can then still degrade the performance but this can be cancelled by the application of an adjacent +C plate.

Thus, in another preferred embodiment of the present invention the display comprises a second +C plate on the side of the display opposite to that of the first +C plate.

Furthermore, the reduction of the thickness and/or birefringence of the TAC film can further improve the optical performance of the compensated display.

When manufacturing coated RM films it is generally advantageous to reduce the number of coating and lamination steps. Thus, it is also possible for example to coat an RM+C plate coated directly onto a +A plate so that the two RM layers form a monolithic film, thus removing a coated layer of adhesive plus a lamination step. The dual layer can then be laminated onto the TAC substrate of the adjacent polariser in a single step. Configurations No. 1,4, 15 and 16 in table 1 and No. 1-8 in table 2 are especially suited to this method of manufacture and are therefore especially preferred.

An LCD according to the present invention may further comprise one or more further optical components such as compensation or retardation films like for example one or more quarter wave retardation films (QWF, λ/4 films) or half wave retardation films (HWF, λ/2 films), positive or negative A, O or C plates or retardation films with twisted, homeotropic, planar, tilted or splayed structure. Particularly preferred are optical films comprising polymerised or crosslinked LC material.

The LCD according to the present invention may be a reflective or transmissive display, and may further comprise a light source, like a conventional backlight, or a reflective layer on the side of the LC cell opposite to that of the first linear polariser. In case of a reflective display with a reflective layer on one side of the LC cell the second linear polariser may be omitted.

The +A and +C plate of the compensator according to the present invention are preferably prepared from a polymerisable LC material by in-situ polymerisation. In a preferred method of preparation the polymerisable LC material is coated onto a substrate, oriented into the desired orientation and subsequently polymerised for example by exposure to heat or actinic radiation as described for example in WO 98/00475 or WO 98/04651.

The polymerisable LC material is preferably a nematic or smectic LC material, in particular a nematic material, and preferably comprises at least one monoreactive polymerisable mesogenic compound and at least one di- or multireactive polymerisable mesogenic compound.

Polymerizable mesogenic mono-, di- and multireactive compounds used for the present invention can be prepared by methods which are known per se and which are described, for example, in standard works of organic chemistry such as, for example, Houben-Weyl, Methoden der organischen Chemie, Thieme-Verlag, Stuttgart.

Suitable polymerisable calamitic LC materials are for example disclosed in WO 93/22397, EP 0 261 712, DE 195 04 224, WO 95/22586, WO 97/00600, GB 2 351 734, WO 98/00475 or WO 98/04651.

The compounds disclosed in these documents, however, are to be regarded merely as examples that shall not limit the scope of this invention.

Examples of especially useful polymerizable mesogenic compounds (reactive mesogens) are shown in the following lists which should, however, be taken only as illustrative and is in no way intended to restrict, but instead to explain the present invention:

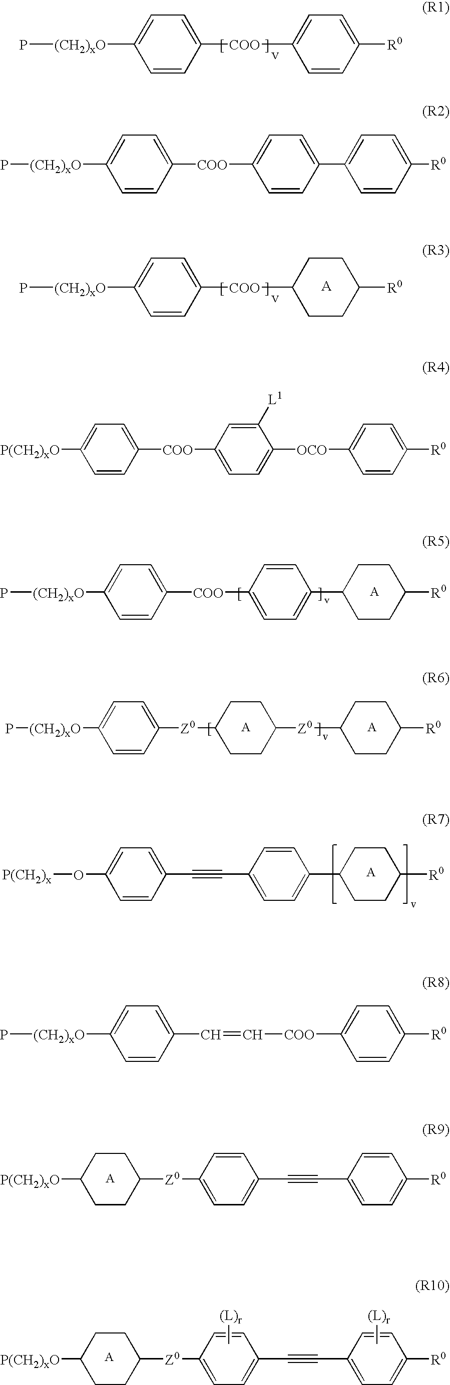

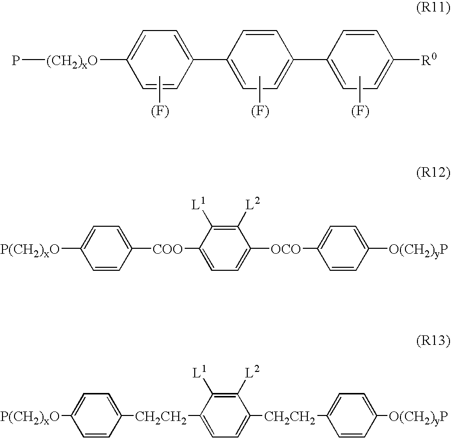

In the above formulae, P is a polymerisable group, preferably an acryl, methacryl, vinyl, vinyloxy, propenyl ether, epoxy, oxetane or styryl group, x and y are identical or different integers from 1 to 12, A is 1,4-phenylene that is optionally mono-, di- or trisubstituted by L¹, or 1,4-cyclohexylene, u and v are independently of each other 0 or 1, Z⁰ is —COO—, —OCO—, —CH₂CH₂—, —CH═CH—, —C═C— or a single bond, R⁰ is a polar group or an unpolar group, Ter is a terpenoid radical like e.g. menthyl, Chol is a cholesteryl group, L, L¹ and L² are independently of each other H, F, Cl, CN or an optionally halogenated alkyl, alkoxy, alkylcarbonyl, alkylcarbonyloxy, alkoxycarbonyl or alkoxycarbonyloxy group with 1 to 7 C atoms, and r is 0, 1, 2, 3 or 4. The phenyl rings in the above formulae are optionally substituted by 1, 2, 3 or 4 groups L.

The term ‘polar group’ in this connection means a group selected from F, Cl, CN, NO₂, OH, OCH₃, OCN, SCN, an optionally fluorinated alkycarbonyl, alkoxycarbonyl, alkylcarbonyloxy or alkoxycarbonyloxy group with up to 4 C atoms or a mono- oligo- or polyfluorinated alkyl or alkoxy group with 1 to 4 C atoms. The term ‘unpolar group’ means an optionally halogenated alkyl, alkoxy, alkycarbonyl, alkoxycarbonyl, alkylcarbonyloxy or alkoxycarbonyloxy group with 1 or more, preferably 1 to 12 C atoms which is not covered by the above definition of ‘polar group’.

The polymerisable LC material preferably comprises one or more achiral monoreactive polymerisable mesogenic compounds and one or more achiral di- or multireacfive polymerisable mesogenic compounds.

A preferred polymerisable LC material comprises
5-70%, preferably 5-50%, very preferably 5-40% by weight of one or more direactive achiral mesogenic compounds,
30-95. % preferably 50-75% by weight of one or more monoreactive achiral mesogenic compounds,
0 to 10% by weight of one or more photoinitiators.

The monoreactive compounds are preferably selected from above formulae R1-R11, in particular R1 and R5, wherein v is 1.

The direactive compounds are preferably selected from above formula R12.

Especially preferred are mixtures comprising one or more polymerisable compounds comprising an acetylene or tolane group with high birefringence, like e.g. compounds of formula Ig above.

Suitable polymerisable tolanes are described for example in GB 2,351,734.

The polymerisable material is preferably dissolved or dispersed in a solvent, preferably in an organic solvent. The solution or dispersion is then coated onto the substrate, for example by spin-coating or other known techniques, and the solvent is evaporated off before polymerisation. In most cases it is suitable to heat the mixture in order to facilitate the evaporation of the solvent.

The polymerisable LC material may additionally comprise a polymeric binder or one or more monomers capable of forming a polymeric binder and/or one or more dispersion auxiliaries. Suitable binders and dispersion auxiliaries are disclosed for example in WO 96/02597. Especially preferred, however, are LC materials not containing a binder or dispersion auxiliary.

In another preferred embodiment the polymerisable LC material comprises an additive that induces or enhances planar alignment of the liquid crystal material on the substrate. Preferably the additive comprises one or more surfactants. Suitable surfactants are described for example in J. Cognard, Mol. Cryst. Liq. Cryst. 78, Supplement 1, 1-77 (1981). Particularly preferred are non-ionic surfactants, very fluorocarbon surfactants, like for example the commercially available fluorocarbon surfactants Fluorad FC-171® (from 3M Co.), or Zonyl FSN® (from DuPont).

Polymerisation of the LC material is preferably achieved by exposing it to actinic radiation. Actinic radiation means irradiation with light, like UV light, IR light or visible light, irradiation with X-rays or gamma rays or irradiation with high energy particles, such as ions or electrons. Preferably polymerisation is carried out by photoirradiation, in particular with UV light. As a source for actinic radiation for example a single UV lamp or a set of UV lamps can be used. When using a high lamp power the curing time can be reduced. Another possible source for photoradiation is a laser, like e.g. a UV laser, an IR laser or a visible laser.

Polymerisation is carried out in the presence of an initiator absorbing at the wavelength of the actinic radiation. For example, when polymerising by means of UV light, a photoinitiator can be used that decomposes under UV irradiation to produce free radicals or ions that start the polymerisation reaction. UV photoinitiators are preferred, in particular radicalic UV photoinitiators. As standard photoinitiator for radical polymerisation for example the commercially available Irgacure® 907, Irgacure® 651, Irgacure® 184, Darocure® 1173 or Darocure® 4205 (all from Ciba Geigy AG) can be used, whereas in case of cationic photopolymerisation the commercially available UVI 6974 (Union Carbide) can be used.

The polymerisable LC material can additionally comprise one or more other suitable components such as, for example, catalysts, sensitizers, stabilizers, chain-transfer agents, inhibitors, co-reacting monomers, surface-active compounds, lubricating agents, wetting agents, dispersing agents, hydrophobing agents, adhesive agents, flow improvers, defoaming agents, deaerators, diluents, reactive diluents, auxiliaries, colourants, dyes or pigments.

In another preferred embodiment the polymerisable material comprises up to 70%, preferably 1 to 50% of a monoreactive non-mesogenic compound with one polymerisable functional group. Typical examples are alkyl acrylates or alkyl methacrylates with alkyl groups of 1 to 20 C atoms.

It is also possible, in order to increase crosslinking of the polymers, to add up to 20% of a non-mesogenic compound with two or more polymerisable functional groups to the polymerisable LC material alternatively or in addition to the di- or multireactive polymerisable mesogenic compounds to increase crosslinking of the polymer. Typical examples for direactive non-mesogenic monomers are alkyl diacrylates or alkyl dimethacrylates with alkyl groups of 1 to 20 C atoms. Typical examples for multireactive non-mesogenic monomers are trimethylpropane trimethacrylate or pentaerythritol tetraacrylate.

It is also possible to add one or more chain transfer agents to the polymerisable material in order to modify the physical properties of the polymer film. Especially preferred are thiol compounds, such as monofunctional thiol compounds like e.g. dodecane thiol or multifunctional thiol compounds like e.g. trimethylpropane tri(3-mercaptopropionate), very preferably mesogenic or liquid crystalline thiol compounds. When adding a chain transfer agent, the length of the free polymer chains and/or the length of the polymer chains between two crosslinks in the inventive polymer film can be controlled. When the amount of the chain transfer agent is increased, the polymer chain length in the obtained polymer film is decreasing.

Alternatively it is possible to prepare the retardation films from a readily synthesized LC polymer that is applied onto a substrate, for example at a temperature above its glass transition temperature or its melting point, or from solution e.g. in an organic solvent, aligned into the desired orientation, and solidified for example by evaporating the solvent or by cooling below the glass temperature or melting point of the LC polymer. If for example a LC polymer with a glass temperature that is higher than ambient temperature is used, evaporation of the solvent or cooling leaves a solid LC polymer film. If for example an LC polymer with a high melting point is used, the LC polymer can be applied as a melt onto the substrate which solidifies upon cooling. LC side chain polymers or LC main chain polymers can be used, preferably LC side chain polymers. The LC polymer should preferably be selected such that its glass transition or melting temperature is significantly higher than the operating tempature of the retarder. For example, LC side chain polymers comprising a polyacrylate, polymethacrylate, polysiloxane, polystyrene or epoxide backbone with laterally attached mesogenic side chains can be used. The LC polymer may also comprise side chains with reactive groups that can be crosslinked after or during evaporation of the solvent to permanently fix the orientation. The LC polymer may also be subjected to mechanical or heat treatment after application to the substrate to improve alignment. The above methods and suitable materials are known to those skilled in the art.

The compensator according to the present invention is especially suitable for use in IPS-LCDs, especially NB-IPS LCDs.

However, the compensator according to the present invention can principally also be used for compensation of other types of LCDs, like for example those of the DAP (deformation of aligned phases) or VA (vertically aligned) mode, like e.g. ECB (electrically controlled birefringence), CSH (colour super homeotropic), VAN or VAC (vertically aligned nematic or cholesteric) displays, MVA (multi-domain vertically aligned) or PVA (patterned vertically aligned) displays, displays of the optically compensated bend (OCB) or pi-cell mode, including conventional OCB, R-OCB (reflective OCB), HAN (hybrid aligned nematic) and pi-cell (π-cell) displays, furthermore in displays of the TN (twisted nematic), HTN (highly twisted nematic) or STN (super twisted nematic) mode, or in AMD-TN (active matrix driven TN) displays.

The following examples should illustrate the present invention without limiting it. Therein, the following abbreviations are used:
Δn birefringence
d layer thickness [μm]
d·Δn optical retardation [nm]
Director director orientation of the LC molecules in the LC cell
Phi azimuthal angle corresponding to a rotation of the LC molecules about the normal of the plane
Theta polar angle corresponding to a rotation of the LC molecules about an axis in the plane of the film

Unless stated otherwise, values of Δn are given at 20° C. and 550 nm.

The optical parameters of the LC cell, polarisers and A and C plates used in the following examples, unless explicitly stated otherwise, are as follows.
Cell gap d: 4 μm
Cell retardation dΔn: 274 nm
Director in dark state: Theta =90, Phi =0 or 90
Director in light state: Theta =90, Phi =45
+A plate Δn: 0.115
+C plate Δn: 0.115

The polarisers are “ideal polarisers”, which means that they show 100% absorbtion of light polarised along the absorbtion direction of the polariser at all wavelengths between 380-780 nm.

The values and plots of the iso-contrast and grey levels in the following examples are obtained by modelling or measurement, respectively, using berreman matrix methods for optical simulations and Eldim EZContrast equipment for viewing angle measurement.

### COMPARISON EXAMPLE 1

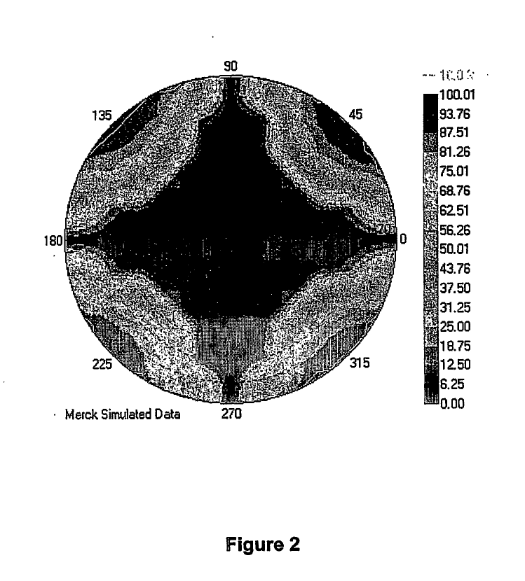

An uncompensated IPS display comprises an LC cell and two linear polarisers. The simulated isocontrast plot is shown in FIG. 2.

### EXAMPLE 1

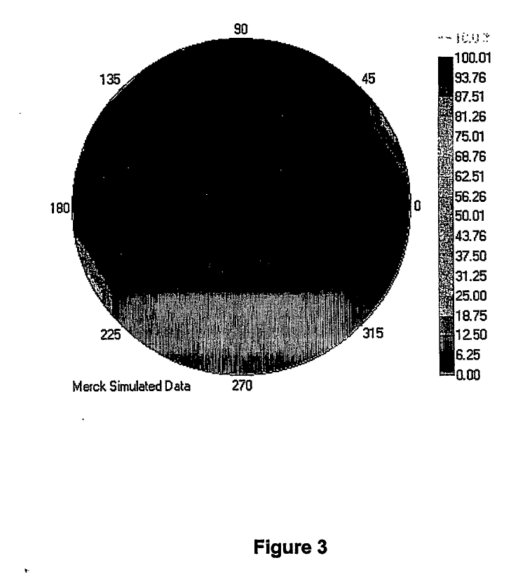

An IPS display comprises a compensator with a +A plate and a +C plate according to configuration No. 1 of table 1 above. The simulated isocontrast plot is shown in FIG. 3.

### EXAMPLE 2

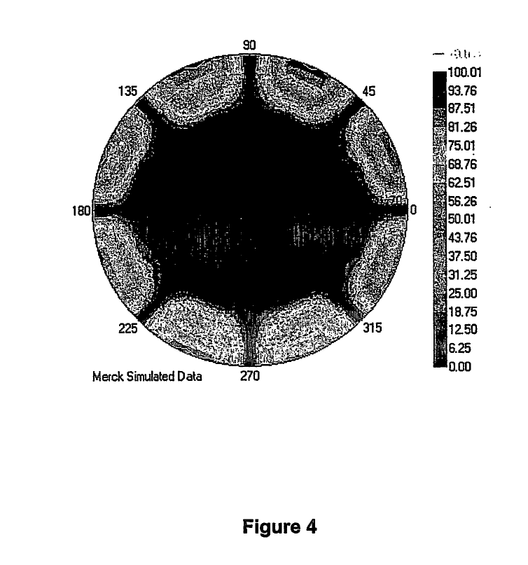

An IPS display comprises a compensator with a +A plate and a +C plate according to configuration No. 4 of table 1 above. The simulated isocontrast plot is shown in FIG. 4.

### EXAMPLE 3

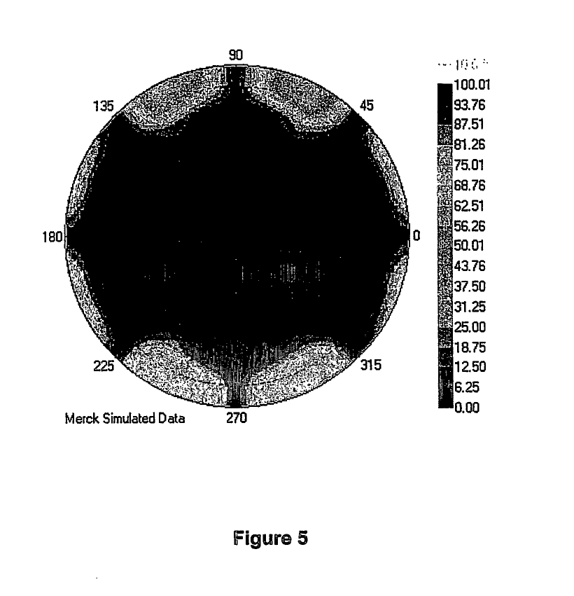

An IPS display comprises a compensator with a +A plate and a +C plate according to configuration No. 1 of table 2 above, including TAC films as polariser substrates. The simulated isocontrast plot is shown in FIG. 5.

### COMPARISON EXAMPLE 2

An uncompensated IPS display has the following configuration

Front polariser (20°)
IPS cell (200°)
Back polariser (110°)

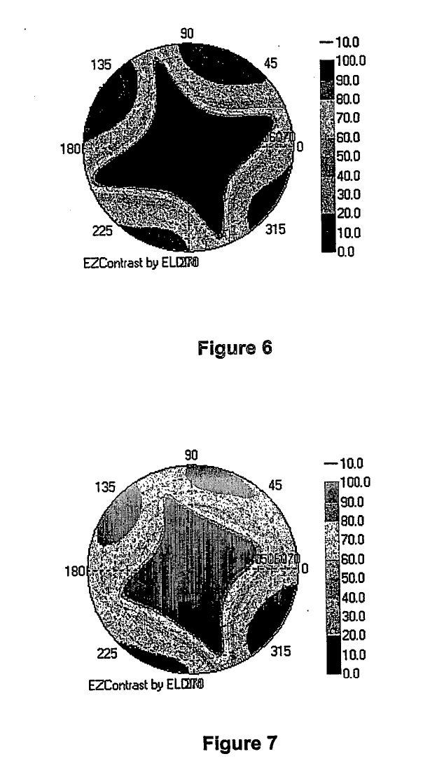

The measured isocontrast plot is shown in FIG. 6.

### EXAMPLE 4

An IPS display comprises a compensator with a +A plate and a +C plate according to the following configuration:

Front polariser (110°)
900 nm +A (20°)
750 nm +C
IPS Cell (200°)
Back Polariser (20°)

The measured isocontrast plot is shown in FIG. 7.

### EXAMPLE 5

An IPS display comprises a compensator with a +A plate and a +C plate according to the following configuration:

Front polariser (110°)
750 nm +C
500 nm +A (110°)
IPS Cell (200°)
Back Polariser (20°)

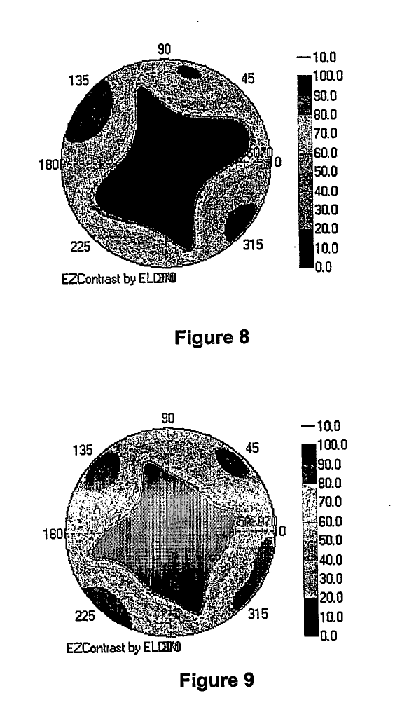

The measured isocontrast plot is shown in FIG. 8.

### EXAMPLE 6

An IPS display comprises a compensator with a +A plate and a +C plate according to the following configuration:

Front polariser (20°)
1250 nm +C
900 nm +A (110°)
IPS Cell (200°)
Back Polariser (110°)

The measured isocontrast plot is shown in FIG. 9.

### EXAMPLE 7

An IPS display comprises a compensator with a +A plate and a +C plate according to the following configuration:

Front polariser (110°)
750 nm +C
900 nm +A (20°)
IPS Cell (200°)
Back Polariser (20°)

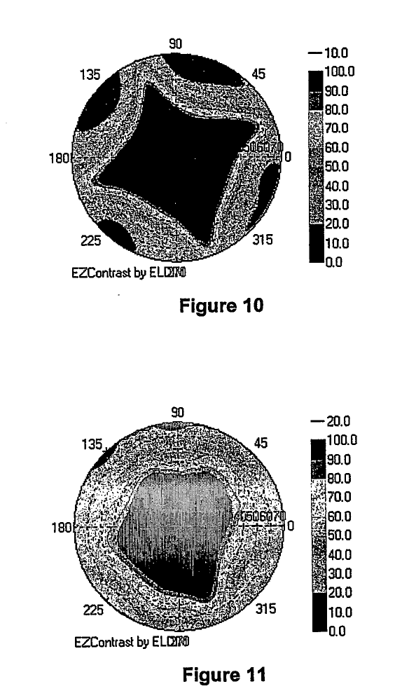

The measured isocontrast plot is shown in FIG. 10.

### EXAMPLE 8

An IPS display comprises a compensator with a +A plate and a +C plate according to the following configuration:

Front polariser (20°)
1000 nm +C
800 nm +A (20°)
IPS Cell (110°)
800 nm +A (110°)
Back Polariser (110°)

The measured isocontrast plot is shown in FIG. 11.

### EXAMPLE 9

An IPS display comprises a compensator with a +A plate and a +C plate according to the following configuration:

Front polariser (20°)
1250 nm +C
800 nm +A (20°)
IPS Cell (110°)
1200 nm +A (110°)
Back Polariser (110°)

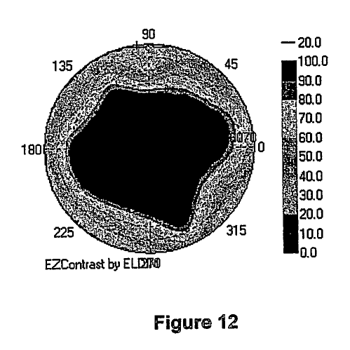

The measured isocontrast plot is shown in FIG. 12.

1. Liquid crystal display (LCD) of the In Plane Switching (IPS) mode comprising a switchable LC cell sandwiched between two polarisers, said LC cell comprising a layer of an LC medium between two plane parallel substrates at least one of which is transparent to incident light, wherein the LC molecules are reoriented by application of an electric field that has a major component substantially parallel to the substrates, characterized in that the LCD comprises
at least one first retardation film comprising optically uniaxial positive calamitic LC material and having an optical axis substantially parallel to the film plane (+A plate),
at least one first retardation film comprising optically uniaxial positive calamitic LC material and having an optical axis substantially perpendicular to the film plane (+C plate).

2. LCD according to claim 1, characterized in that it comprises one +A plate and one +C plate.

3. LCD according to claim 1, characterized in that the optical axis of the +A plate is parallel to the stretch axis of the polariser that is situated on the same side of the LC cell as the +A plate.

4. LCD according to claim 1, characterized in that the +A plate and/or +C plate comprise polymerised or crosslinked calamitic LC material.

5. LCD according to claim 1, characterized in that the +A plate comprises polymerised or crosslinked calamitic LC material with planar orientation.

6. LCD according to claim 1, characterized in that the +C plate comprises polymerised or crosslinked calamitic LC material with homeotropic orientation.

7. LCD according to claim 1, characterized in that the position of the individual components is selected from the following configurations 1 to 24

| | | | | | |
|---|---|---|---|---|---|
| 1) | P(90) | C | A(90) | LC(0) | P(0) |
| 2) | P(90) | A(0) | C | LC(0) | P(0) |
| 3) | P(90) | LC(0) | A(90) | C | P(0) |
| 4) | P(90) | LC(0) | A(0) | C | P(0) |
| 5) | P(90) | A(0) | LC(0) | C | P(0) |
| 6) | P(90) | A(90) | LC(0) | C | P(0) |
| 7) | P(90) | A(90) | C | LC(90) | P(0) |
| 8) | P(90) | C | LC(0) | A(90) | P(0) |
| 9) | P(90) | LC(0) | C | A(90) | P(0) |
| 10 | P(90) | C | A(0) | LC(90) | P(0) |
| 11) | P(90) | C | LC(0) | A(0) | P(0) |
| 12) | P(90) | LC(0) | C | A(0) | P(0) |
| 13) | P(90) | LC(90) | C | A(90) | P(0) |
| 14) | P(90) | C | A(0) | LC(90) | P(0) |
| 15) | P(90) | LC(90) | A(0) | C | P(0) |
| 16) | P(90) | C | A(90) | LC(90) | P(0) |
| 17) | P(90) | C | LC(90) | A(90) | P(0) |
| 18) | P(90) | A(0) | C | LC(90) | P(0) |
| 19) | P(90) | LC(90) | A(90) | C | P(0) |
| 20) | P(90) | A(0) | LC(90) | C | P(0) |
| 21) | P(90) | A(90) | LC(90) | C | P(0) |
| 22) | P(90) | A(90) | C | LC(90) | P(0) |
| 23) | P(90) | C | LC(90) | A(0) | P(0) |
| 24) | P(90) | LC(90) | C | A(0) | P(0) |

wherein A is a +A plate, C is a +C plate, LC is the switchable LC cell of the display, and P is a linear polariser, and the numbers in brackets denote the orientation angle (in degrees) of the optical axis of the +A and +C plate, the polarising direction of the polarisers P, or the preferred orientation direction of the LC molecules in the LC cell, respectively, in the direction parallel to the plane of the individual films or to the substrates of the LC cell.

8. LCD according to claim 7, characterized in that the position of the individual components is selected from the following configurations 1 to 8

| | | | | | | | | | |
|---|---|---|---|---|---|---|---|---|---|
| 1) | S | P(90) | C | S | A(90) | LC(0) | S | P(0) | S |
| 2) | S | P(90) | S | C | A(90) | LC(0) | S | P(0) | S |
| 3) | S | P(90) | S | LC(0) | A(0) | C | S | P(0) | S |
| 4) | S | P(90) | S | LC(0) | A(0) | S | C | P(0) | S |
| 5) | S | P(90) | S | LC(90) | A(0) | C | S | P(0) | S |
| 6) | S | P(90) | S | LC(90) | A(0) | S | C | P(0) | S |
| 7) | S | P(90) | S | C | A(90) | LC(90) | S | P(0) | S |
| 8) | S | P(90) | C | S | A(90) | LC(90) | S | P(0) | S |

wherein A, C, P, amd LC have the meanings given in claim 7 claim 8, and S denotes a transparent substrate.

9. LCD according to claim 1, characterized in that the the +A plate and +C plate are situated on the same side of the switchable LC cell.

10. LCD according to claim 1, characterized in that the +A plate and/or the +C plate are situated between the substrates of the LC cell.

11. Compensator comprising at least one +A plate and at least one +C plate as defined in claim 1, and optionally comprising at least one linear polariser.
